(19) United States
(12) Patent Application Publication
(10) Pub. No.: US 2017/0184035 A1
(43) Pub. Date: Jun. 29, 2017

(54) Valve Device

(71) Applicant: Continental Automotive GmbH, Hannover (DE)

(72) Inventors: Peter WELTEROTH, Glashuetten (DE); Rolf ANSCHICKS, Butzbach/Fauerbach (DE)

(21) Appl. No.: 15/039,322

(22) PCT Filed: Nov. 20, 2014
(86) PCT No.: PCT/EP2014/075112

§ 371 Date: Mar. 8, 2017

(30) Foreign Application Priority Data
Nov. 26, 2013 (DE) 10 2013 224 141.0

(51) Int. Cl. F02D 9/10; F02F 1/42; F02B 31/04

(52) U.S. Cl. CPC F02D 9/104; F02B 31/04; F02F 1/42; F02D 9/10; F02M 35/12

(57) ABSTRACT

A valve device for a motor vehicle includes: a housing; a duct arranged in the housing; a flap arranged in the duct and configured to close the duct; a shaft mounted in the housing, upon which shaft the flap is attached; an electric motor configured to drive the shaft; and a stationary conducting element arranged in the duct downstream of the flap.

### CROSS-REFERENCE TO RELATED APPLICATIONS

This is a U.S. national stage of application No. PCT/EP2014/075112, filed on 20 Nov. 2014, which claims priority to the German Application No. 10 2013 224 141.0 filed 26 Nov. 2013, the content of both incorporated herein by reference.

### BACKGROUND OF THE INVENTION

1. Field of the Invention

The invention relates to a valve device for a motor vehicle with a housing, a duct present in the housing, a flap arranged in the duct for closing the duct, wherein the flap is attached to a shaft and the shaft is mounted in the housing, and with an electric motor for driving the shaft.

2. Related Art

Such valve devices are used, for example, as throttle flap connectors or exhaust gas recirculation valves and have been known for some time. The rotatably mounted flap allows the duct to be closed completely or opened such that a desired mass throughflow occurs. If a gas stream flows around the opened flap, eddies are formed on the edge and the back of the flap, so that the formerly laminar flow transforms into a turbulent flow downstream of the flap. The disadvantage here is that the eddying leads to a pressure fall and that a turbulent flow obstructs the management of the gas stream. Also, sensors arranged in the gas flow for regulating the gas flow are unable to establish precise values, which has a further negative effect on the gas flow regulation.

### SUMMARY OF THE INVENTION

It is therefore an object of the invention to provide a valve device with which the turbulence from the flap is minimized, and with which the valve device can be produced at a low cost.

According to an aspect of the invention, the object is achieved in that a stationary conducting element is arranged in the duct downstream of the flap.

The eddying leading to the turbulent flow is disrupted by the arrangement of a stationary conducting element, so that the turbulent flow transforms back into a laminar flow in a significantly shorter time.

In an advantageous embodiment, the conducting element is formed integrally with the wall of the duct. Firstly, this allows a secure fixing of the conducting element in the duct. Secondly, in this way the conducting element can be well integrated into the valve device. In particular for cast metal housings, in this way the conducting element can be cast together with the housing, avoiding subsequent mounting of the conducting element in the housing.

According to a further embodiment, too great a reduction of the effective flow cross-section with simultaneously good influencing of the turbulent flow is achieved if the conducting element is configured as a web and divides the duct into two part channels.

The turbulent flow is influenced optimally if the conducting element has the same orientation as a fully opened flap.

To ensure that the conducting element itself generates minimum turbulence, according to a further advantageous embodiment the ends of the conducting element are configured rounded.

Because of the construction space available, it may be advantageous to configure the duct bent downstream of the flap. In this case, the conducting element is arranged in this region of the duct and adapted to the bent course of the duct.

A bent duct leads to the two part channels having different lengths. It has proved advantageous in these cases to configure the cross-section of the conducting element such that the part flows in the two part channels pass over the conducting element at the same time, so that they meet again at the end of the conducting element at the same time. This avoids the occurrence of new turbulence. In one possible configuration of the cross-section, the surface of the conducting element facing the radially outer part channel is curved towards the part channel, while the surface of the conducting element facing the radially inner part channel is curved away from the part channel. With this configuration, the cross-section in the radially outer part channel is reduced, which leads to an increase in flow speed. In the radially inner part channel however, the cross-section is enlarged, whereby the flow speed is reduced. In this way, the different lengths of the part channels can be adapted to each other fluidically.

### BRIEF DESCRIPTION OF THE DRAWINGS

The invention is explained in more detail with reference to several exemplary embodiments. In the drawings:

FIG. 1 shows a section through a valve device according to the invention;

FIG. 2 shows a further section through the valve device in FIG. 1,

FIG. 3 shows a second embodiment of the valve device,

FIG. 4 shows a section of the valve device in FIG. 3,

FIG. 5 shows a perspective depiction of a third embodiment, and

FIG. 6 shows a section through the conducting element in FIG. 5.

### DETAILED DESCRIPTION OF THE PRESENTLY PREFERRED EMBODIMENTS

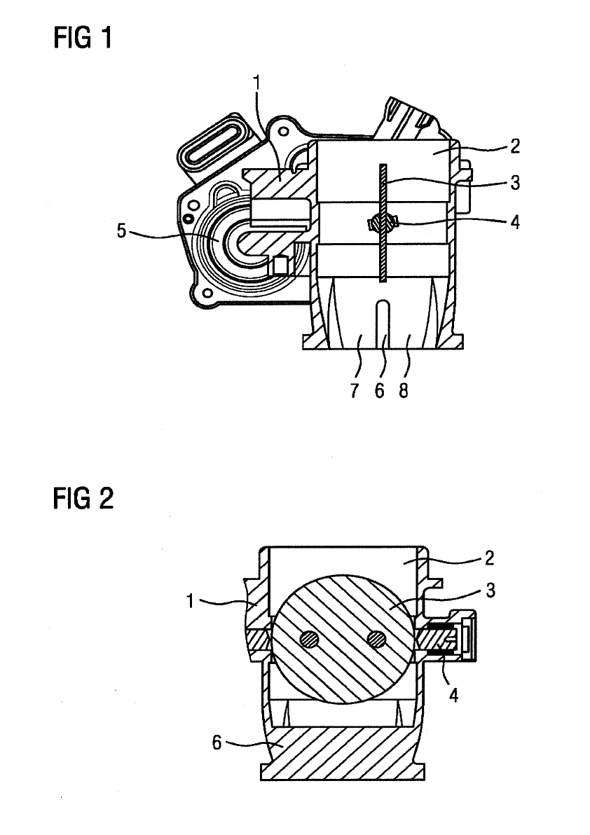

The valve device in FIGS. 1 and 2 is an exhaust gas recirculation valve in a motor vehicle, wherein the section in FIG. 2 is rotated by 90° relative to the section in FIG. 1. It consists of a cast housing 1 of metal with a duct 2. A flap 3 for closing the duct 2 is arranged in the duct 2, wherein the flap 3 is attached to a shaft 4. The shaft 4 is mounted in the housing 1 and is driven via an electric motor arranged longitudinally in a chamber 5 of the housing 1. The duct 2 is configured linearly and has a conducting element 6 downstream of the flap 3. The conducting element 6 is cast with the housing 1 and thus connected integrally to the housing 1. When the flap 3 is fully opened, the conducting element 6 has the same orientation as the flap 3. Because of the one-piece configuration with the housing 1, the conducting element 6 divides the duct 2 into two identical part channels 7, 8.

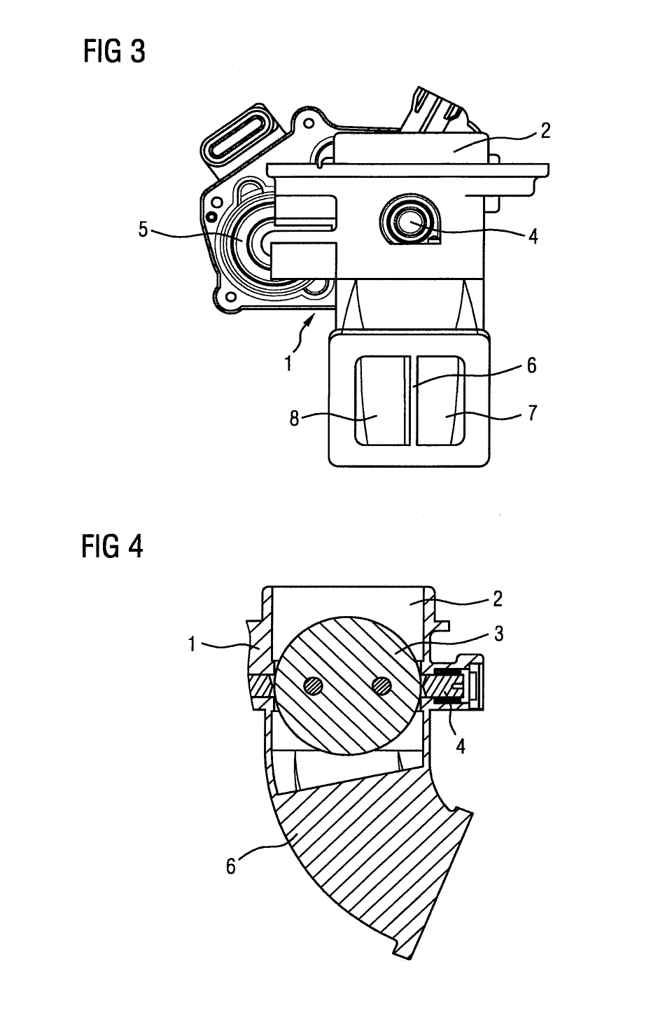

The valve device according to FIGS. 3 and 4, in contrast to the valve device according to FIG. 1, has a duct 2 that is bent downstream of the flap 3. The flap 3 and the conducting element 6 again have the same orientation, and the conducting element 6 divides the duct 2 into two symmetrical and identical part channels 7, 8. The conducting element 6 is configured integrally with the housing 1.

The valve device according to FIG. 5 also has a bent duct 2. The flap 3 and the conducting element 6, in contrast to FIG. 4, are arranged offset by 90° to the curvature of the duct 2 so that the conducting element 6 divides the duct 2 into a radially inner part channel 7 and a radially outer part channel 8. In this way, the radially outer part channel 8 has a greater center length than the radially inner part channel 8.

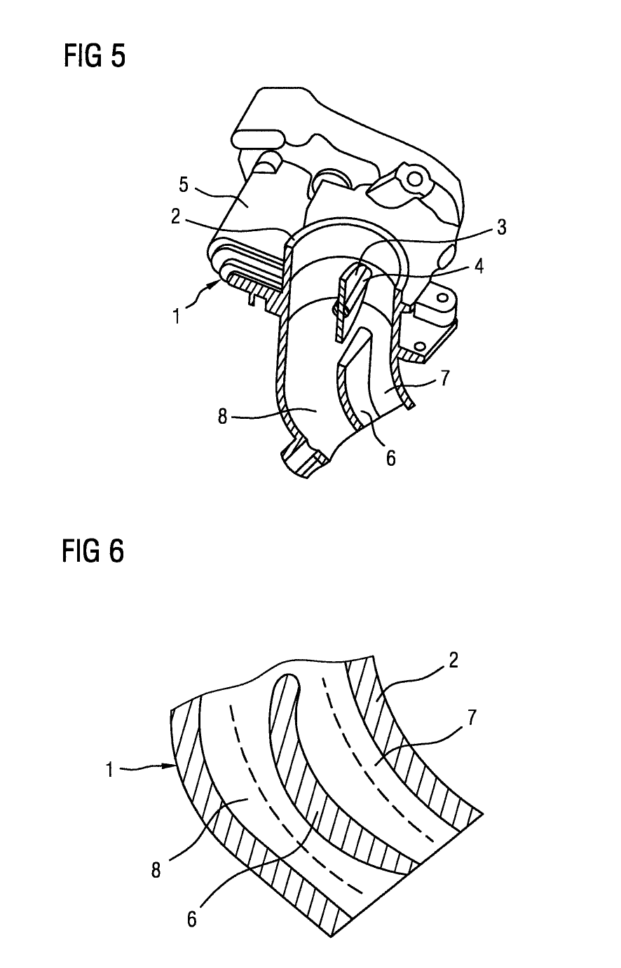

FIG. 6 shows a further embodiment of the conducting element 6 which has a cross-section in the form of a vane. The surface of the conducting element 6 facing the radially outer part channel 8 is curved towards the part channel 8, while the surface of the conducting element 6 facing the radially inner part channel 7 is curved away from the part channel 7. With this configuration, the cross-section in the radially outer part channel 8 is reduced, which leads to a rise in flow speed. In the radially inner part channel 7 however, the cross-section is enlarged, whereby the flow speed is reduced. At the end of the conducting element 6, the two part flows meet at the same time and hence with little turbulence.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A valve device for a motor vehicle, comprising:
a housing;
a duct (2) arranged in the housing;
a flap (3) arranged in the duct (2) and configured to close the duct;
a shaft mounted in the housing, upon which shaft the flap is attached;
an electric motor configured to drive the shaft; and
a stationary conducting element (6) arranged in the duct (2) downstream of the flap (3).

9. The valve device as claimed in claim 8, wherein the stationary conducting element (6) is integral with a wall of the duct (2).

10. The valve device as claimed in claim 8, wherein the stationary conducting element (6) is configured as a web and divides the duct (2) into two part channels (7, 8).

11. The valve device as claimed in claim 10, wherein the stationary conducting element (6) has the same orientation as the fully opened flap (3).

12. The valve device as claimed in claim 8, wherein the stationary conducting element (6) has rounded ends.

13. The valve device as claimed in claim 8, wherein the duct (2) has a bent portion arranged downstream of the flap (3), and wherein the stationary conducting element (6) is arranged in the bent region of the duct (2) and is configured so as to be adapted to the bent course of the duct (2).

14. The valve device as claimed in claim 13, wherein the stationary conducting element (6) is arranged so as to divide the duct (2) into a radially inner part channel (7) and a radially outer part channel (8), and wherein the stationary conducting element (6) has a cross-section configured such that a surface of the stationary conducting element (6) facing the radially outer part channel (8) is curved towards the outer part channel (8) while a surface of the stationary conducting element (6) facing the radially inner part channel (7) is curved away from the inner part channel (7).
